(19) United States
(12) Patent Application Publication
(10) Pub. No.: US 2006/0032253 A1
(43) Pub. Date: Feb. 16, 2006

(54) Driving control method for central air conditioner

(75) Inventors: Won-Hee Lee, Seoul (KR); Yoon-Jei Hwang, Seoul (KR); Seung-Youp Hyun, Seoul (KR); Jae-Hoon Sim, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/109,714

(22) Filed: Apr. 20, 2005

(30) Foreign Application Priority Data
Aug. 14, 2004 (KR) 64107/2004

(51) Int. Cl. F25B 7/00; F25B 1/00; F25B 49/00; B60H 1/32; F25B 1/10

(52) U.S. Cl. 62/175; 62/510; 62/228.5

(57) ABSTRACT

A driving control method for a central air conditioner having at least two compressors of a small capacity and a large capacity, respectively, includes, upon a user's selecting a cooling mode between a weak cooling mode or a strong cooling mode, judging a load size in the selected cooling mode, and differently driving the compressors based on the judged load size. A load corresponding ability is enhanced thus to reduce power consumption, thereby increasing an energy efficiency and making the user feel comfortable.

### BACKGROUND OF THE INVENTION

1. Field of the Invention

The present invention relates to a central air conditioner, and more particularly, to a driving control method for a central air conditioner capable of increasing a load corresponding ability and an energy efficiency and enhancing a user's comfort.

2. Description of the Conventional Art

Generally, a central air conditioner is a kind of centralized cooling/heating system that cools or heats air at one position by using a cooling/heating apparatus and supplies the cooled or heated air to an individual space through a duct.

FIG. 1 is a schematic perspective cut away view showing a central air conditioner installation using a heat pump type refrigerating cycle in accordance with the conventional art, and FIG. 2 is a schematic block diagram of the central air conditioner of FIG. 1 in accordance with the conventional art.

As shown in FIGS. 1 and 2, the conventional central air conditioner includes one outdoor unit 1 fixedly installed outside a building, an air handler unit 2 connected to a first heat exchanger of the outdoor unit 1 by a refrigerant pipe and fixedly installed at a basement of a building or etc., an air supplying duct 3 and an air exhausting duct 4 respectively connected to an inlet and an outlet of the air handler unit 2 and installed at an outer wall of each floor of a building, and zone controllers 5a to 5d installed between the air supplying duct 3 and the air exhausting duct 4 and dividing air supply and an air exhaustion to each floor.

The outdoor unit 1 includes at least one compressor 1a installed in a case, for compressing refrigerant gas, a first heat exchanger 1b connected to the compressor 1a by a refrigerant pipe, for condensing refrigerant gas (at the time of a cooling operation) into a liquid state or absorbing latent heat (at the time of a heating operation), an expansion unit 1c for reducing a pressure of the refrigerant whereby it becomes gas, and an outdoor fan (not shown) for supplying external air to the first heat exchanger 1b and thereby enhancing a heat exchanging function of the first heat exchanger 1b.

The air handler unit 2 includes a second heat exchanger 2a having one end connected to the first heat exchanger 1b and another end connected to the expansion unit 1c, and an air supplying fan (not shown) for blowing cold or hot air to the air supplying duct 3. The case of the air handler unit 2 forms an air passage of a ‘U’ shape for accommodating the second heat exchanger 2a and the air supplying fan (not shown) therein. To an inlet of the air passage, the air supplying duct 3 is connected. Also, to an outlet of the air passage, the air exhausting duct 4 is connected.

The air supplying duct 3 and the air exhausting duct 4 are respectively connected to the inlet and the outlet of the air handler unit 2 thereby to be installed at corresponding zones Z1 and Z2, respectively. A discharge port 3a for supplying cold air to a corresponding zone is provided at the air supplying duct 3, and a suction port 4a for sucking indoor air is provided at the air exhausting duct 4.

The zone controllers 5a to 5d for supplying cold air to a corresponding zone are valves installed between the air supplying duct 3 and the air exhausting duct 4 installed at the corresponding zones Z1 and Z2. The zone controllers are connected to a control unit (not shown) for detecting the temperature, humidity, etc. in a corresponding zone and for automatically opening/closing the valves upon comparing the detected value and a preset value, or are manually adjusted.

FIG. 3 is a diagram explaining a driving control method for a compressor by a thermostat in the conventional central air conditioner.

As shown, the conventional central air conditioner controls an indoor unit or an outdoor unit by a weak cooling signal or a strong cooling signal provided by the thermostat, thereby driving a compressor in the minimum driving mode or in the maximum driving mode.

For example, in case that the central air conditioner is a single-stage model, only a driving mode preset by the driving control signal from the thermostat (for example, the maximum driving) is performed. Also, in case that the central air conditioner is a two-stage model, if a driving control signal for a strong cooling is provided from the thermostat, the indoor unit and the outdoor unit are operated in a preset maximum driving mode, and if a driving control signal for a weak cooling is provided from the thermostat, the indoor unit and the outdoor unit are operated in a preset minimum driving mode.

In the conventional central air conditioner, the outdoor unit and the indoor unit are operated in the preset maximum driving mode or in the minimum driving mode even if two compressors having different capacities are used. Accordingly, a load corresponding ability is lowered thereby to increase power consumption. Also, since the air conditioner is operated in a preset driving mode, a load corresponding ability is lowered thereby not to make a user feel comfortable.

### SUMMARY OF THE INVENTION

Therefore, an object of the present invention is to provide a driving control method for a central air conditioner which is capable of enhancing a load corresponding ability of a plurality of compressors having different capacities by judging a load size and by differently driving each compressor.

To achieve these and other advantages and in accordance with the purpose of the present invention, as embodied and broadly described herein, there is provided a driving control method for a central air conditioner having at least two compressors of a small capacity and a large capacity, respectively, the method comprising, upon a user's selecting a weak cooling mode or a strong cooling mode of the compressor, judging a load size in the selected cooling mode, and differently driving the respective compressors based on the thusly judged load size.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic perspective cut away view of a central air conditioner installation using a heat pump type refrigerating cycle in accordance with the conventional art;

FIG. 2 is a schematic block diagram of the conventional central air conditioner of FIG. 1;

FIG. 3 is a diagram explaining a driving control method for a compressor by a thermostat in the conventional central air conditioner;

FIG. 4 is a flowchart showing a driving control method for a central air conditioner according to the present invention;

FIGS. 5A to 6B are flowcharts showing a driving control method for a central air conditioner under a low load condition according to the present invention;

FIGS. 7 to 12 are flowcharts showing a driving control method for a central air conditioner under a high load condition according to the present invention;

FIGS. 13A and 13B are graphs respectively showing a load corresponding ability according to the conventional art and the present invention; and

FIG. 14 is a table comparing a load corresponding ability and power consumption according to the conventional art and the present invention.

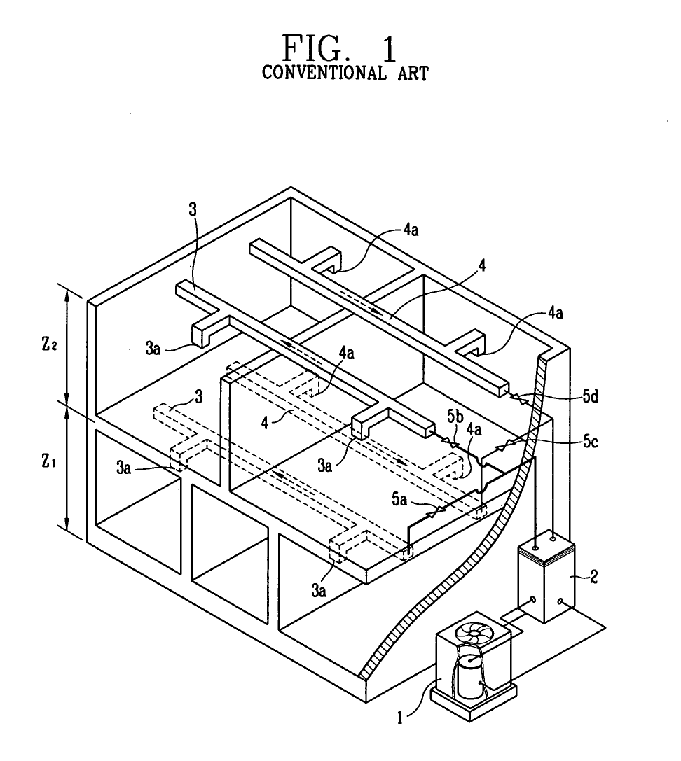

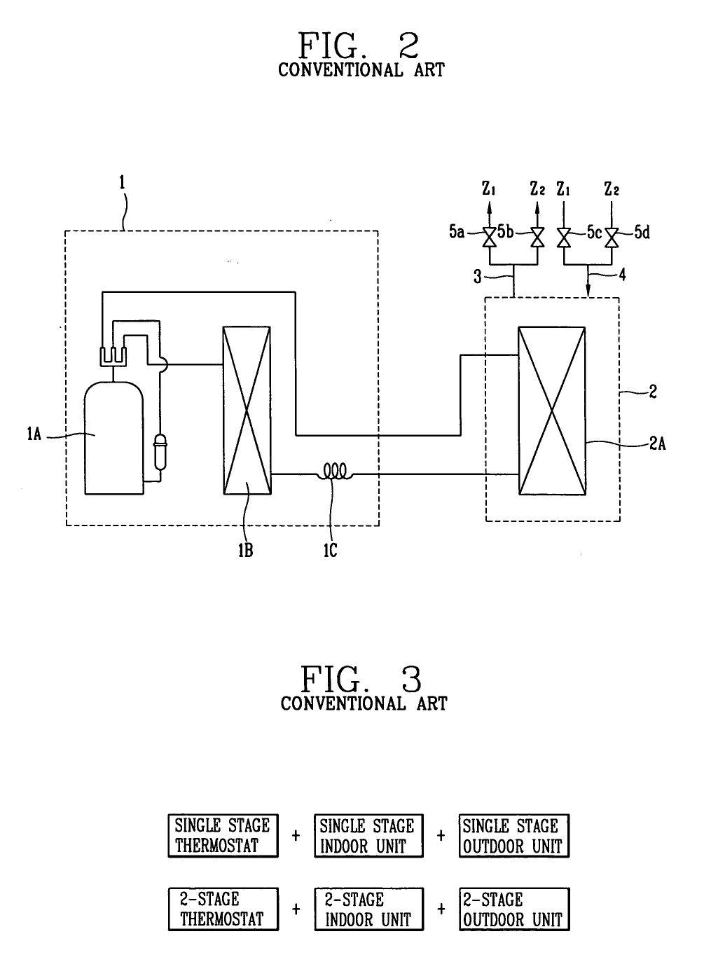

### DETAILED DESCRIPTION OF THE INVENTION

Description will now be given in detail of the present invention, with reference to the accompanying drawings.

Hereinafter will be explained a driving control method for a central air conditioner which is capable of increasing an energy efficiency by decreasing the consumption of power by increasing a load corresponding ability, and which is also capable of making a user feel comfortable. Even though a central air conditioner having only two compressors of respectively different capacities is disclosed in the present application for the sake of convenience, the present invention can be applied to a central air conditioner having more than two compressors.

The system according to the present invention to which the method for controlling a driving central air conditioner is applied is composed of at least two compressors having respectively different capacities, a heat exchanger, a fan, a fan motor, an accumulator, etc. The present invention can perform a three-stage driving by using two compressors having respectively different capacities under the conventional thermostat for two-stage is used. That is, the central air conditioner can be operated in a maximum driving mode (for example, a driving of 100%) by driving the at least two compressors having respectively different capacities, and the central air conditioner can be operated in a middle driving mode (for example, a driving of 60%) by driving only one compressor of a larger capacity among the at least two compressors having respectively different capacities. Also, the central air conditioner can be operated in a minimum driving mode (for example, a driving of 40%) by driving only one compressor of a smaller capacity among the at least two compressors having respectively different capacities.

Preferred embodiments of the driving control method for a central air conditioner according to the present invention will be explained as follows.

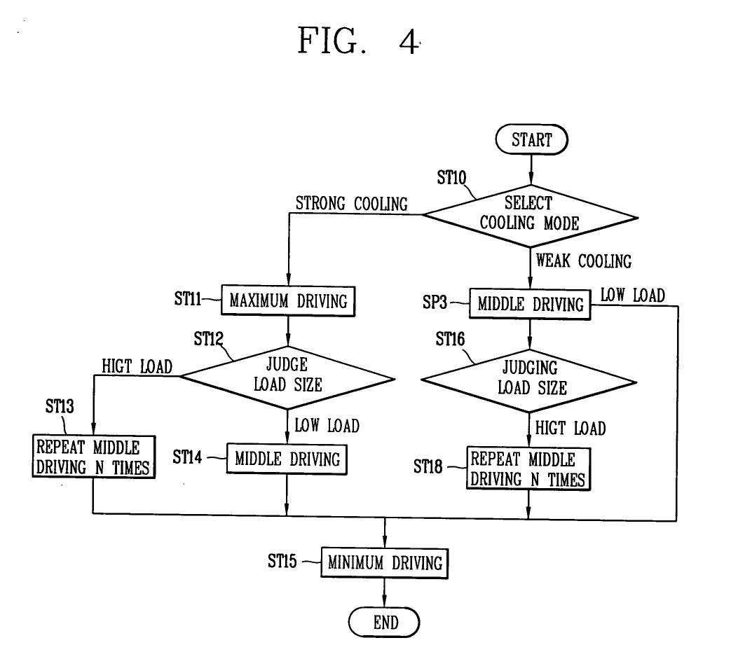

FIG. 4 is a flowchart showing a driving control method for a central air conditioner according to the present invention.

As shown, the driving control method for a central air conditioner having at least two compressors of a small capacity and a large capacity, respectively includes, upon a user's selecting a weak cooling mode or a strong cooling mode of the air conditioner (St10); driving the compressors in a maximum driving mode by driving the compressors of a large capacity and a small capacity when a driving signal for a strong cooling is inputted from a thermostat when the strong cooling mode has been selected (St11), judging a load size at the time of driving the compressors in the maximum driving mode under the selected strong cooling mode (St12), differently driving the respective compressors based on the thusly judged load size and thereby driving the compressors in a middle driving mode (St13, St14), and driving the compressors in a minimum driving mode when it is judged that the load is released when a preset time has elapsed (St15).

In case that a driving signal for a weak cooling is outputted from the thermostat under the selected weak cooling mode, one compressor having a small capacity or a large capacity is driven thereby to operate the compressor in a middle driving mode (St16), the load size is judged at the time of driving the compressor in the middle driving mode under the selected weak cooling mode (St17), and the compressor is repeatedly driven in the middle driving mode N times based on the judged load size (St18) or the compressor is driven in a minimum driving mode (St15).

It is preferable to decrease the number of times of turning on/off of the compressor in order to decrease power consumption and to increase a load corresponding ability. Accordingly, in the driving control method for a central air conditioner according to the present invention, the compressor is differently driven on the basis of the judged load size. That is, in the driving control method for a central air conditioner according to the present invention, if the load is a high load, the compressor is repeatedly driven N times in the middle driving mode at the time of converting the maximum driving mode (for example, a driving of 100%) into the middle driving mode (for example, a driving of 60%) or at the time of converting the middle driving mode (for example, a driving of 60%) into the minimum driving mode (for example, a driving of 40%). On the contrary, if the load is a low load, the compressor is continuously driven in the middle driving mode without being repeatedly turned on/off. Accordingly, the load corresponding ability is enhanced thereby to reduce power consumption and to provide a more comfortable environment to the user.

The judgment of the load size can be variously performed. For example, when the indoor temperature is greatly different from a desired temperature set by the user or the outdoor temperature is greatly different from a desired temperature set by the user, it is judged that the load is a high load. Also, when the indoor temperature is only minutely different from the desired temperature set by the user or the outdoor temperature is only minutely different from the desired temperature set by the user, it is judged that the load is a low load. As another embodiment, when the outdoor temperature is less than a reference temperature (for example, 82 degrees Fahrenheit or 83 degrees Fahrenheit), it is judged that the load is a low load. On the contrary, when the outdoor temperature is greater than the reference temperature, it is judged that the load is a high load. As still another embodiment, the judgment of the load size is performed on the basis of the outdoor temperature and the previous driving state of the compressor, thereby differently driving the compressor.

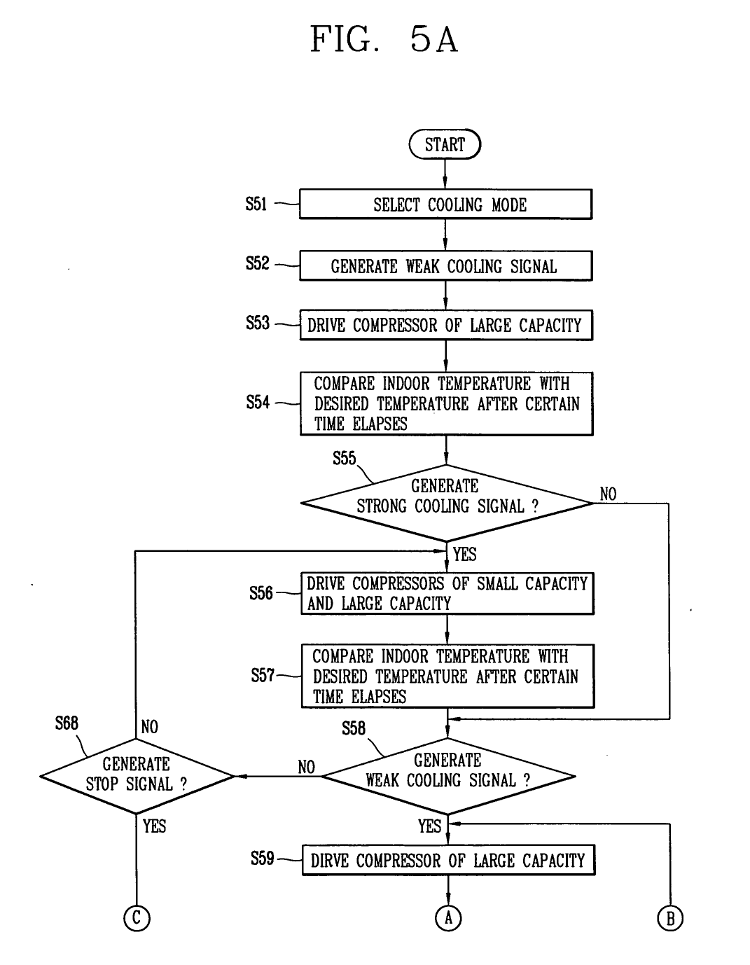

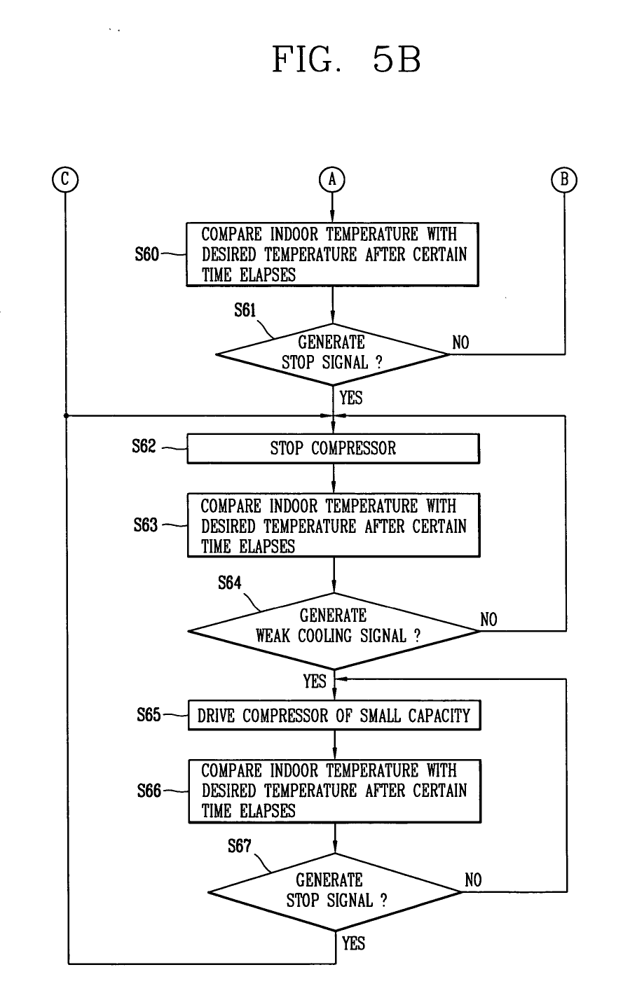

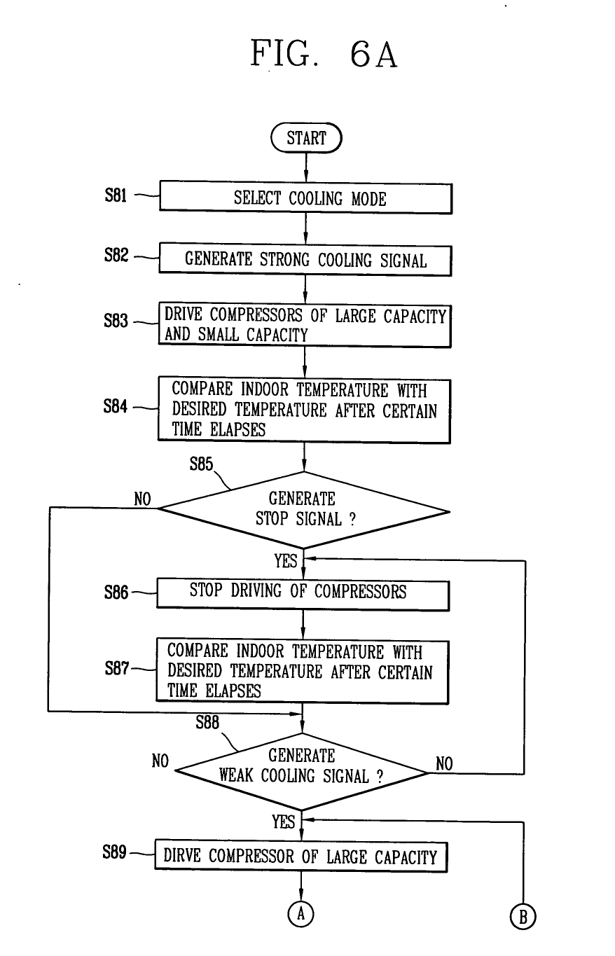

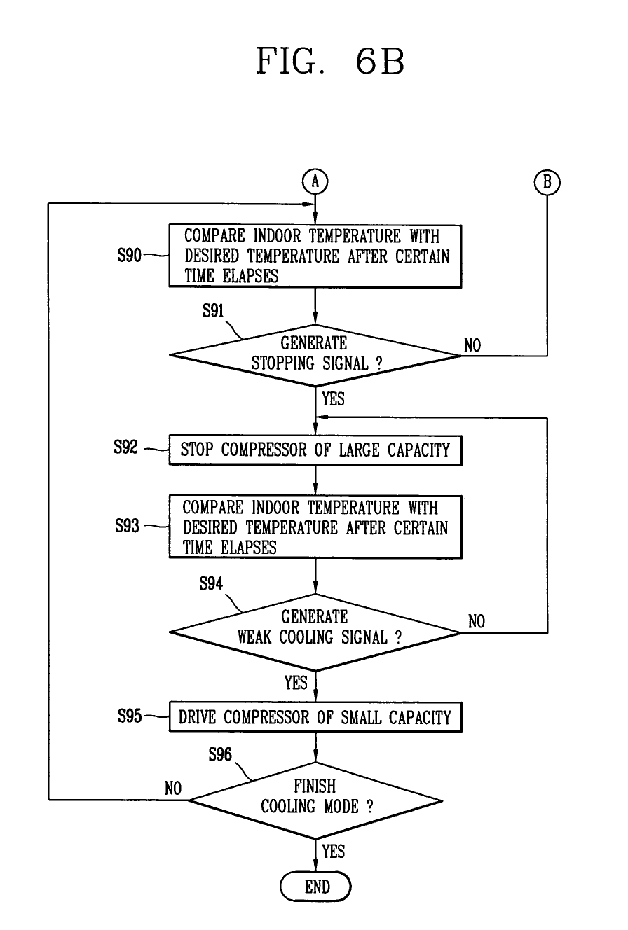

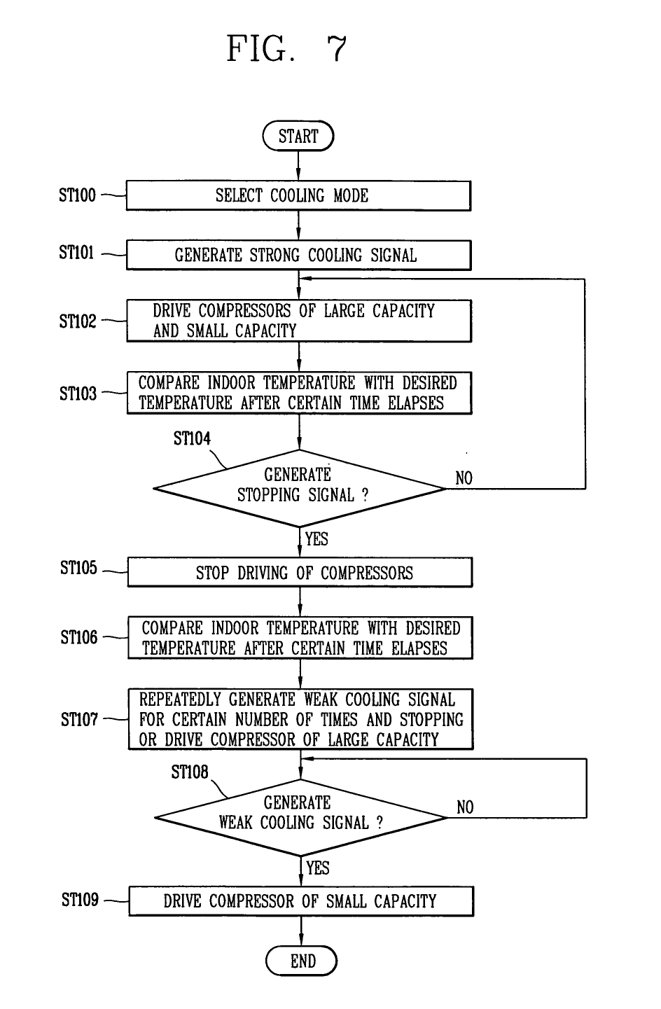

The driving control method for a central air conditioner will be explained in more detail in respect of a low load condition (FIGS. 5A to 6B) and in respect of a high load condition (FIGS. 7 to 12).

FIGS. 5A and 5B are flowcharts showing a driving control method for a central air conditioner under a low load condition according to the present invention.

As shown, at the time of an initial driving, the thermostat of the central air conditioner generates a weak cooling signal according to a user's cooling mode selection, and a compressor of a large capacity is driven in accordance with the weak cooling signal (for example, driving of 60%) (St51-St53). According to the kind of the thermostat, a strong cooling signal may be generated at the initial driving of the compressor. An algorithm implemented according to another embodiment of the present invention in case that a strong cooling signal is generated at the initial driving of the compressor will be explained later.

Then, after a certain time elapses and thereby the indoor load has been reduced, the load size is judged. If, according to the judgement result, the thermostat generates a strong cooling signal (Y2), then the compressors of a small capacity and a large capacity are both driven (for example, driving of 100%) thereby to reduce the indoor load (St54-St56).

After a certain time elapses while the compressors of a small capacity and a large capacity are being driven, the load size is again judged. If, according to the judgement result, the thermostat generates a weak cooling signal (Y1), then the compressor of a large capacity is driven (for example, driving of 60%) (St57-St59).

After a certain time elapses while the compressor of a large capacity is being driven, the load size is again judged. If, in accordance with the judgement result, the thermostat generates a compressor on/off control signal for stopping the compressor, then the driving of the compressor is stopped (St60-St62).

After a certain time elapses, the thermostat generates a weak cooling signal (Y1). Then, the compressor of a small capacity is driven (St63-St65). That is, if the thermostat generates the stopping signal after generating the weak cooling signal Y1 and then generates the weak cooling signal Y1 again, it is judged that the load is reduced to a sufficient degree. Accordingly, only the compressor of a small capacity is operated for performing a minimum driving.

Since it is judged that the indoor load is reduced to a sufficient degree, only the compressor of a small capacity is operated at the time of generating the weak cooling signal Y1 (St66, St67). That is, when a certain time elapses while the compressor of a small capacity is driven, the indoor temperature is compared with the desired temperature. On the basis of the comparison result, if the thermostat generates a compressor on/off control signal for stopping the driving of the compressor, the driving of the compressor of a small capacity is stopped. Then, after a certain time elapses, if the thermostat generates the weak cooling signal Y1, the compressor of a small capacity is operated.

The compressors of a small capacity and a large capacity are operated (St56). After a certain time elapses, the load size is judged (St57). If, in accordance with the judgement result, the thermostat generates a compressor on/off control signal for stopping the compressor, the driving of the compressors of a small capacity and a large capacity is stopped (St68). When a certain time elapses after the compressors of a small capacity and a large capacity are stopped, the load size is judged. If, in accordance with the judgement result, the thermostat generates the weak cooling signal Y1, the compressor of a large capacity is operated (St57-St59). That is, while the compressors of a large capacity and a small capacity are operated by a strong cooling signal, if a weak cooling signal is generated after a certain time elapses and the load is reduced or s if a weak cooling signal is generated after the compressor is stopped for a certain time, the compressor of a large capacity is operated thereby to reduce the load.

According to another embodiment of the present invention, the thermostat may generate a strong cooling signal at the initial driving of the compressor. An algorithm for generating a strong cooling signal at the initial driving of the compressor according to this embodiment of the present invention will be explained as follows.

FIGS. 6A and 6B are flowcharts showing a driving control method for a central air conditioner under a low load condition according to the present invention.

As shown in FIGS. 6A and 6B, when a cooling mode is selected by a user, the thermostat generates a strong cooling signal and the compressors of a small capacity and a large capacity are operated in accordance with the strong cooling signal (St81-St83).

After a certain time elapses while the compressors of a small capacity and a large capacity are operated, the load size is judged. If, in accordance with the judgement result, the thermostat generates a compressor on/off control signal for stopping the compressor, the driving of the compressors of a small capacity and a large capacity is stopped (St84-St86).

When a certain time elapses after the compressors of a small capacity and a large capacity are stopped, the load size is judged. If, in accordance with the judgement result, the thermostat generates a weak cooling signal, the compressor of a large capacity is operated (St87-St89).

When a certain time elapses while the compressors of a small capacity and a large capacity are operated (St83), the load size is judged (St84). If, in accordance with the judgement result, the thermostat generates a compressor on/off control signal for stopping the compressor, the driving of the compressor of a large capacity is stopped (St90-St92).

After a certain time elapses, the load size is judged. If, in accordance with the judgement result, the thermostat generates a weak cooling signal, the compressor of a small capacity is operated (St93-St95).

Then, the driving of the compressor is finished when the user inputs a cooling mode finishing signal (St96).

FIG. 7 is a flowchart showing a driving control method for a central air conditioner under a high load condition according to the present invention.

As shown in FIGS. 7, when a cooling mode is selected by a user, the thermostat generates a strong cooling signal and the compressors of a small capacity and a large capacity are both operated in accordance with the strong cooling signal (St100-St102).

When a certain time elapses while the compressors of a small capacity and a large capacity are operated, the load size is judged. If, in accordance with the judgement result, the thermostat generates a compressor on/off control signal for stopping the compressor, the driving of the compressors of a small capacity and a large capacity is stopped (St103-St105).

After a certain time elapses, the load size is judged. According to the judgement result, the thermostat repeatedly generates a weak cooling signal, for thereby repeatedly driving or stopping the compressor of a large capacity (St106-St107). For example, in order to stabilize the load after the initial driving of the compressor, the compressor of a large capacity is repeatedly operated approximately five times.

Then, if the thermostat generates a weak cooling signal as it is judged that the indoor load is reduced to a sufficient degree, the compressor of a small capacity is operated (St108-St109).

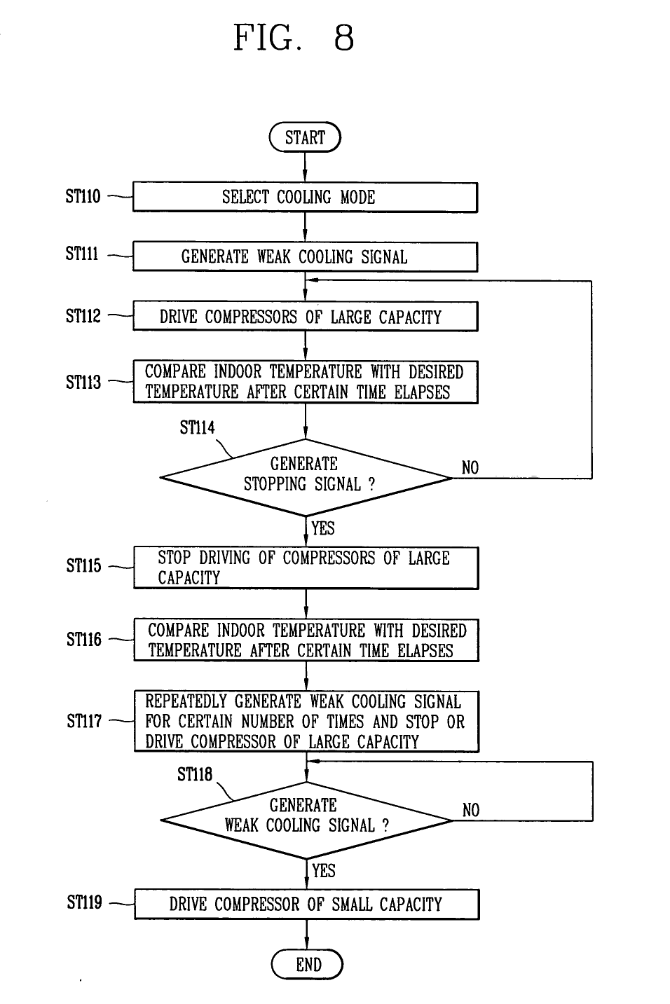

FIG. 8 is a flowchart showing a driving control method for a central air conditioner under a high load condition according to another embodiment of the present invention.

As shown in FIG. 8, when a cooling mode is selected by a user, the thermostat generates a weak cooling signal and the compressor of a large capacity is operated by the weak cooling signal (St110-St112).

When a certain time elapses, the load size is judged. If, in accordance with the judgement result, the thermostat generates a compressor on/off control signal for stopping the compressor, the driving of the compressor of a large capacity is stopped (St113-St115).

After a certain time elapses, the load size is judged. According to the judgement result, the thermostat repeatedly generates a weak cooling signal, for thereby repeatedly driving or stopping the compressor of a large capacity (St116-St117). For example, in order to stabilize the load after the initial driving of the compressor, the compressor of a large capacity is repeatedly operated approximately five times. Then, if the thermostat generates the weak cooling signal after it is judged that the indoor load is stabilized to a sufficient degree, the compressor of a small capacity is operated (St116-St117).

Finally, if it is judged that the indoor load is stabilized to a sufficient degree, the thermostat generates the weak cooling signal and the compressor of a small capacity is operated in accordance with the weak cooling signal (St118-St119).

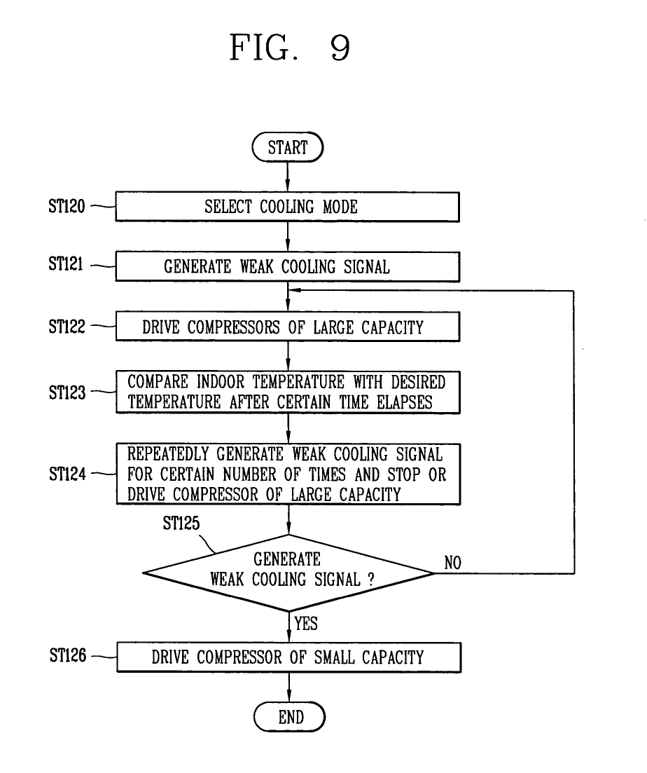

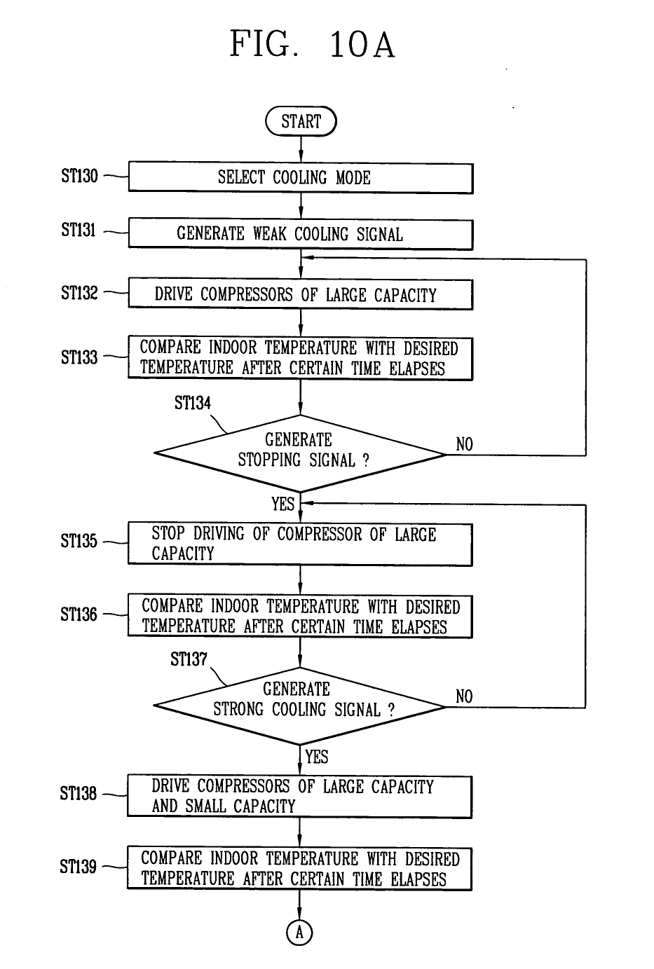

FIG. 9 is a flowchart showing a driving control method for a central air conditioner under a high load condition according to still another embodiment of the present invention.

As shown in FIG. 9, when a cooling mode is selected by a user, the thermostat generates a weak cooling signal and the compressor of a large capacity is operated by the weak cooling signal (St120-St122).

After a certain time elapses, the load size is judged. According to the judgement result, the thermostat repeatedly generates a weak cooling signal, for thereby repeatedly driving or stopping the compressor of a large capacity (St123-St124). For example, in order to stabilize the load after the initial driving of the compressor, the compressor of a large capacity is repeatedly operated approximately five times.

Finally, when it is judged that the indoor load is stabilized to a sufficient degree, the thermostat generates a weak cooling signal and the compressor of a small capacity is operated by the weak cooling signal (St125-St126).

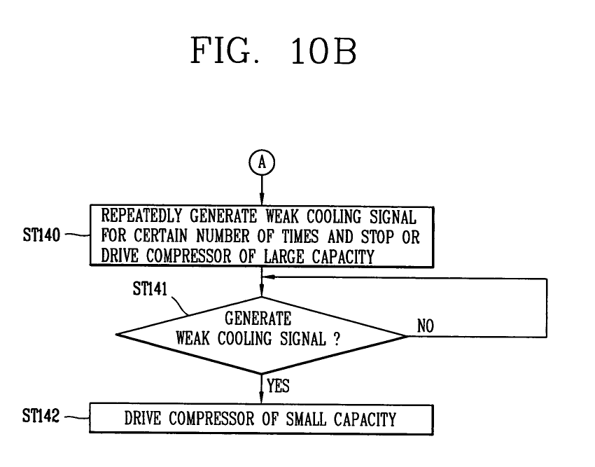

FIGS. 10A and 10B are flowcharts showing a driving control method for a central air conditioner under a high load condition according to still another embodiment of the present invention.

As shown in FIGS. 10A and 10B, when a cooling mode is selected by a user, the thermostat generates a weak cooling signal and the compressor of a large capacity is operated by the weak cooling signal (St130-St135).

After a certain time elapses, the load size is judged. If, according to the judgement result, the thermostat generates a compressor on/off control signal for achieving a strong cooling effect, the compressors of a large capacity and a small capacity are operated (St136-St138).

After a certain time elapses, the load size is judged. According to the judgement result, the thermostat repeatedly a weak cooling signal, for thereby repeatedly driving or stopping the compressor of a large capacity (St139-St140). For example, in order to stabilize the load after the initial driving of the compressor, the compressor of a large capacity is repeatedly operated approximately five times.

Then, if the thermostat generates a weak cooling signal as it is judged that the indoor load is stabilized to some degree, the compressor of a small capacity is operated (St141-St142).

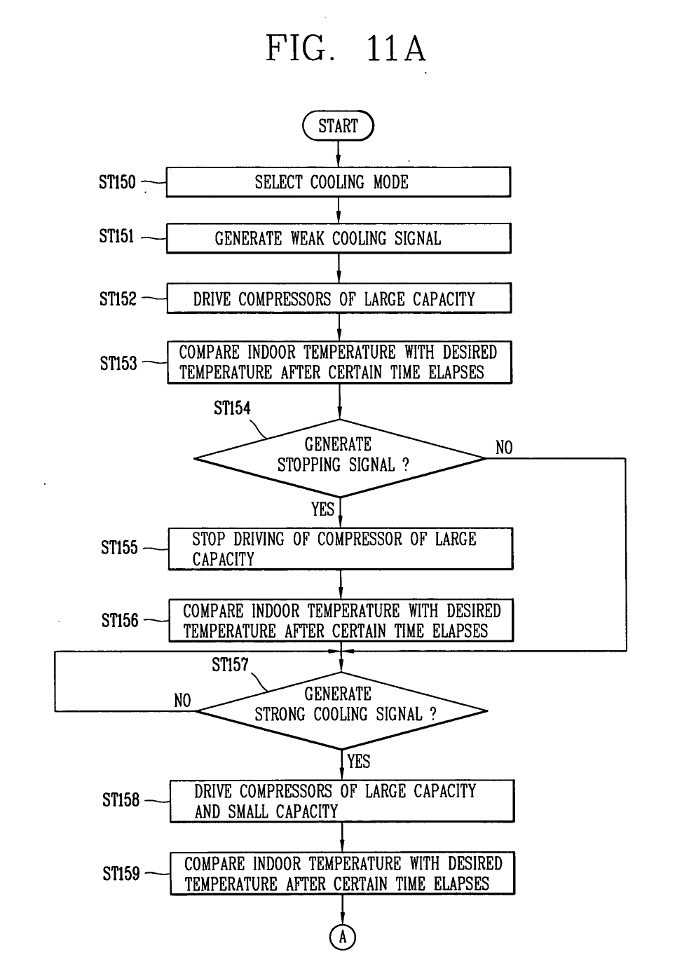

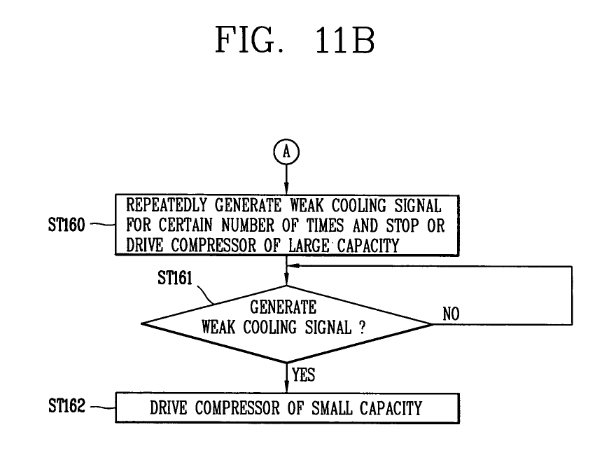

FIGS. 11A and 11B are flowcharts showing a driving control method for a central air conditioner under a high load condition according to still another embodiment of the present invention.

As shown in FIGS. 11A and 11B, when a cooling mode is selected by a user, the thermostat generates a weak cooling signal and the compressor of a large capacity is operated by the weak cooling signal (St150-St152).

After a certain time elapses, the load size is judged. If, according to the judgement result, the thermostat generates a strong cooling signal, the compressors of a large capacity and a small capacity are both operated in accordance with the strong cooling signal (St153-St155).

After a certain time elapses, the load size is judged. By the judgement result, the thermostat repeatedly generates a weak cooling signal, for thereby repeatedly driving or stopping the compressor of a large capacity (St159-St160). For example, in order to stabilize the load after the initial driving of the compressor, the compressor of a large capacity is repeatedly operated approximately five times.

Then, if the thermostat generates a weak cooling signal as it is judged that the indoor load is stabilized to some degree, the compressor of a small capacity is operated (St161-St162).

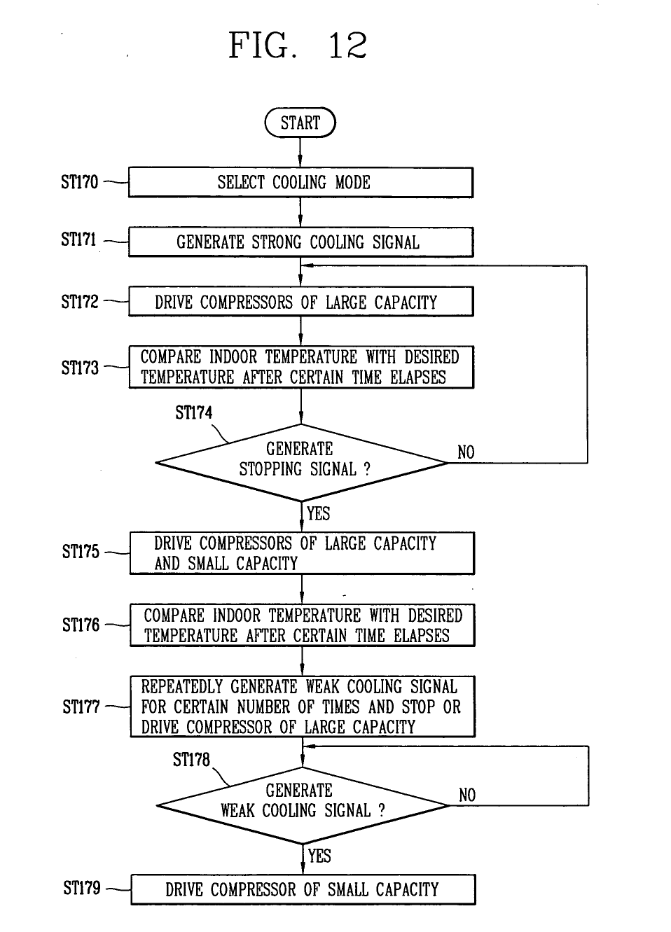

FIG. 12 is a flowchart showing a driving control method for a central air conditioner under a high load condition according to still another embodiment of the present invention.

As shown in FIG. 12, when a cooling mode is selected by a user, the thermostat generates a weak cooling signal and the compressor of a large capacity is operated by the weak cooling signal (St170-St172).

After a certain time elapses, the load size is judged. If, in accordance with the judgement result, the thermostat generates a strong cooling signal, the compressors of a large capacity and a small capacity are both operated in accordance with the strong cooling signal (St173-St175).

After a certain time elapses, the load size is judged. In accordance with the judgement result, the thermostat repeatedly generates a weak cooling signal, for thereby repeatedly driving or stopping the compressor of a large capacity (St176-St177). For example, in order to stabilize the load after the initial driving of the compressor, the compressor of a large capacity is repeatedly operated approximately five times.

Then, if the thermostat generates a weak cooling signal as it is judged that the indoor load is stabilized to a sufficient degree, the compressor of a small capacity is operated (St178-St179).

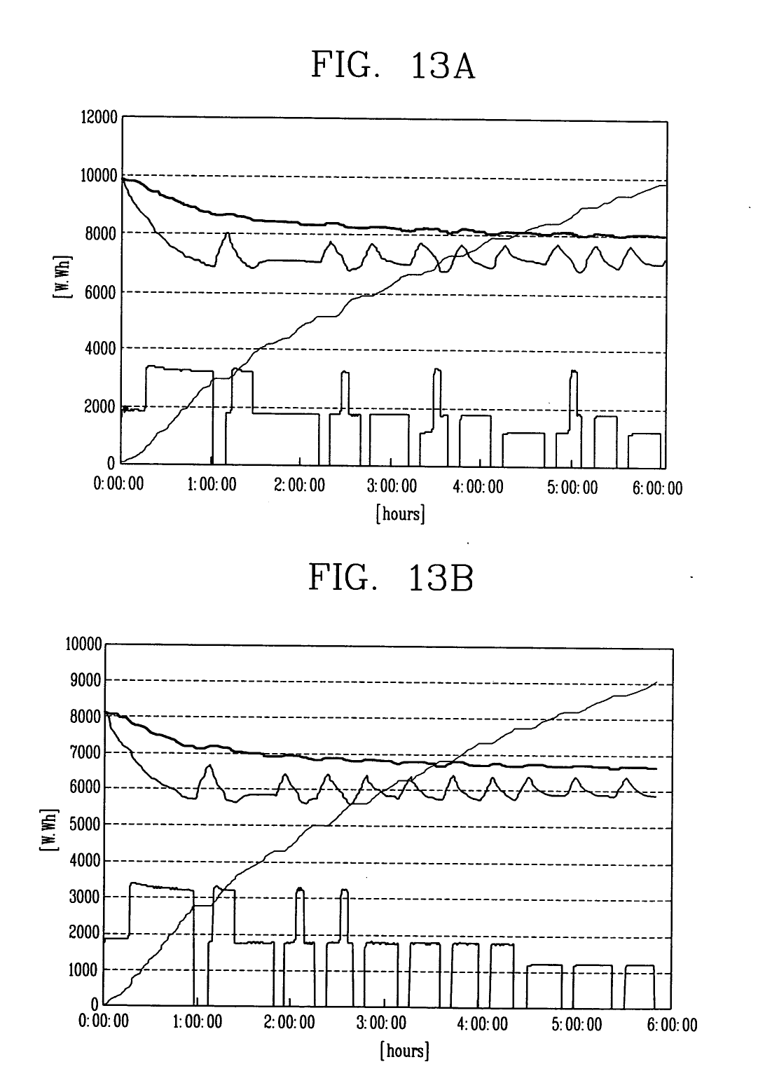

FIGS. 13A and 13B are graphs respectively showing a load corresponding ability according to the conventional art and the present invention.

As shown in FIG. 13A, in the conventional art, a minimum driving (for example, driving of 40%) is performed before the initial load is completely reduced, so that the number of times of a maximum driving (for example, driving of 100%) is a great many due to the lack of the load corresponding ability. However, as shown in FIG. 13B, in the central air conditioner using a three-stage control algorithm according to the present invention, a middle driving (for example, driving of 60%) is repeatedly performed under a high load condition until the load is reduced to some degree. Then, when the load is stabilized, a minimum driving (for example, driving of 40%) is performed. Accordingly, the load corresponding ability of the compressor is enhanced, thereby reducing power consumption and making the user feel comfortable.

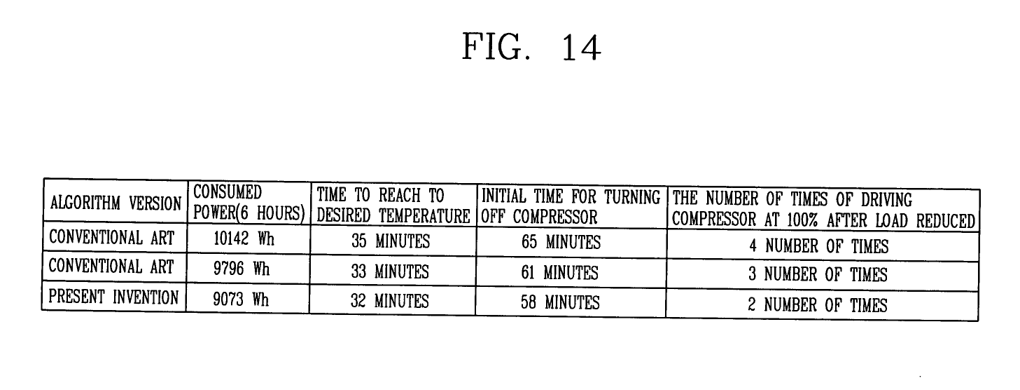

FIG. 14 is a table comparing a load corresponding ability and power consumption according to the conventional art and the present invention.

As shown in FIG. 14, in the central air conditioner using a three-stage control algorithm according to the present invention, power consumption is reduced thereby to enhance the energy efficiency, and the load corresponding ability is enhanced thereby to make the user feel comfortable. That is, the load corresponding ability was enhanced in the high load condition and thereby the number of times that the compressor is operated in the maximum driving mode (for example, driving of 100%) was reduced. Accordingly, power consumption was more enhanced than in the conventional art.

As aforementioned, in the present invention, when at least two compressors having different capacities are operated, the compressors are operated in a three-stage driving mode thereby to enhance a load corresponding ability of the air conditioner. Also, since a driving mode of the compressor is determined by judging the load size, power consumption is reduced thereby to enhance the energy efficiency and to make the user feel comfortable.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A driving control method for a central air conditioner having at least two compressors of a small capacity and a large capacity, respectively, the method comprising:
upon a user's selecting a cooling mode among a weak cooling mode or a strong cooling mode, judging a load size in the selected cooling mode; and
differently driving the respective compressors based on the thusly judged load size.

2. The method of claim 1, wherein the step of judging the load size comprises:
driving both the compressors of a small capacity and a large capacity in a maximum driving mode when a strong cooling signal is outputted from a thermostat while the strong cooling mode is selected; and
judging the load size at the time of driving the compressors in the maximum driving mode while the strong cooling mode is selected.

3. The method of claim 1, wherein the step of judging the load size comprises:
driving one compressor having a small capacity or a large capacity in a middle driving mode when a weak cooling signal is outputted from a thermostat while the weak cooling mode is selected; and
judging the load size at the time of driving the compressor in the middle driving mode while the weak cooling mode is selected.

4. The method of claim 1, wherein in the step of driving the compressor, when it is judged that the load is a high load, the compressor is repeatedly driven N times in a middle driving mode.

5. The method of claim 4, wherein the step of driving the compressor further comprises driving the compressor in a minimum driving mode when it is judged that the load is reduced after a certain time elapses.

6. The method of claim 1, wherein in the step of judging the load size, when an indoor temperature is greatly different from a desired temperature set by a user or an outdoor temperature is greatly different from the desired temperature set by the user, it is judged that the load is a high load, and when the indoor temperature is only minutely different from the desired temperature set by the user or the outdoor temperature is only minutely different from the desired temperature set by the user, it is judged that the load is a low load.

7. The method of claim 1, wherein in the step of judging the load size, when an outdoor temperature is less than a reference temperature, it is judged that the load is a low load, and when the outdoor temperature is greater than the reference temperature, it is judged that the load is a high load.

8. The method of claim 1, wherein in the step of judging the load size, the load size is judged on the basis of an outdoor temperature and previous driving states of the compressors.

9. The method of claim 1, wherein in the step of driving the compressors, a maximum driving mode for simultaneously driving both the compressor of a small capacity and the compressor of a large capacity, a middle driving mode for driving only the compressor of a large capacity, and a minimum driving mode for driving only the compressor of a small capacity are performed.

10. A driving control method for a central air conditioner having at least two compressors of a small capacity and a large capacity, respectively, the method comprising:
lo upon a user's selecting a cooling mode among a weak cooling mode and a strong cooling mode, judging a load size in the selected cooling mode; and
driving the compressors based on the judged load size, wherein if the load is judged a high load, the compressors are repeatedly driven N times in a middle driving mode and if the load is judged a low load, the compressors are driven once in the middle driving mode at the time of converting from a maximum driving mode of simultaneously driving both the compressor of a small capacity and the compressor of a large capacity into the middle driving mode for driving only the compressor of a large capacity or at the time of converting from the middle driving mode into a minimum driving mode for driving only the compressor of a small capacity.

11. The method of claim 10, wherein the step of driving the compressors further comprises driving the compressors in the minimum driving mode when it is judged that the load has been reduced after a certain time elapses.

12. The method of claim 10, wherein in the step of judging the load size, when an indoor temperature is greatly different from a desired temperature set by a user or an outdoor temperature is greatly different from the desired temperature set by the user, it is judged that the load is a high load, and when the indoor temperature is only minutely different from the desired temperature set by the user or the outdoor temperature is only minutely different from the desired temperature set by the user, it is judged that the load is a low load.

13. The method of claim 10, wherein in the step of judging the load size, when an outdoor temperature is less than a reference temperature, it is judged that the load is a low load, and when the outdoor temperature is greater than the reference temperature, it is judged that the load is a high load.

14. The method of claim 10, wherein in the step of judging the load size, the load size is judged on the basis of an outdoor temperature and previous driving states of the compressors.
